(19) United States
(12) Patent Application Publication
(10) Pub. No.: US 2018/0229352 A1
(43) Pub. Date: Aug. 16, 2018

(54) TORQUE WRENCH STRUCTURE

(71) Applicant: OGC TORQUE CO., LTD., Taichung City (TW)

(72) Inventor: WUN-JIN GUO, Taichung City (TW)

(21) Appl. No.: 15/812,574

(22) Filed: Nov. 14, 2017

(30) Foreign Application Priority Data
Feb. 16, 2017 (TW) 106105035

(51) Int. Cl. B25B 23/142

(52) U.S. Cl. CPC B25B 23/1427

(57) ABSTRACT

A torque wrench structure includes an outer tube, a driving member, a resisting member, a sleeve member, and a torque adjusting device. The outer tube is provided with an axially disposed housing space. The driving member has one end provided with a driver and the other end provided with a connecting end, wherein the connecting end is disposed at one end of the outer tube and inserted into the housing space. The resisting member is slidably disposed in the housing space and connected with the connecting end. The sleeve member is disposed between the outer tube and the resisting member. The torque adjusting device is disposed at one end of the outer tube away from the driver, so as to be operated to adjust the torque value.

### BACKGROUND OF THE INVENTION

### 1.Field of the Invention The present invention relates to tools, and more particularly, to a torque wrench structure.

### 2.Description of the Related Art

As shown by U.S. Pat. No. 8,245,606, a torque wrench is disposed, comprising a hollow tube; a driving rod pivotally disposed in the hollow tube and providing with a driver; a roller carrier slidably disposed in the hollow tube and pivotally connected with one end of the driving rod away from the driver; a screw stud combined with the roller carrier; a compression spring mounted around a protrusion of the screw stud; and an adjustment device disposed at another end of the hollow tube away from the driving rod for resisting against the compression spring, such that the compression level of the compression spring is adjusted by use of the thread, thereby adjusting the torque of the torque wrench.

During the operation of the torque wrench, the screw stud slides in the hollow tube as a feedback due to the counterforce of the torque wrench. To prevent the screw stud from heavy friction against the inner wall of the hollow tube, a lubrication oil is added between the screw stud and the hollow tube. However, the amount of the lubrication oil decreases as the time goes by, causing the lubrication effect to become lower. As a result, the torque transmission effect of the torque wrench is adversely affected.

Also, the protrusion of the screw stud is to be mounted by the compression spring. For enabling the compression spring to be mounted around the screw stud, the outer diameter of the protrusion thereof is slightly smaller than the inner diameter of the compression spring. However, a gap is thereby produced between the screw stud and the compression spring. As a result, the compression spring is unable to be mounted around the screw stud and disposed in alignment with the axis of the screw stud, such that elements possibly shake. As a result, a negative effect is imposed upon the torque transmission of the torque wrench.

In addition, the hollow tube undergoes a thermal processing in the molding procedure thereof, so as to acquire higher rigidity and hardness. However, during the thermal processing, a thermal deformation possibly occurs, causing the hollow tube to be bent and deformed. As a result, the inner diameter of the hollow tube is unable to be consistent. When the compression spring is disposed in the hollow tube, during the operation of the torque wrench, the center of the compression spring deviates from the axial center of the hollow tube, and the torque transmission of the torque wrench is easily affected. Therefore, it is desirable to resolve the issues of the friction between the screw stud and the hollow tube and the processing procedure of the hollow tube.

### SUMMARY OF THE INVENTION

For improving the issues above, an embodiment of the present invention discloses a torque wrench structure. By use of a sleeve member disposed between the outer tube and the resisting member, the contact square measure between the resisting member and the sleeve member is reduced, so as to lower the friction therebetween. During the operation of the torque wrench, the sliding motion of the resisting member is improved, thereby enhancing the torque transmission of the torque wrench structure.

An embodiment of the present invention provides a torque wrench structure, comprising:

an outer tube provided with an axially disposed housing space;

a driving member having one end thereof provided with a driver and the other end thereof provided with a connecting end, the driving member pivotally disposed at one end of the outer tube, the connecting end inserted into the housing space;

a resisting member slidably disposed in the housing space and connected with the connecting end;

a sleeve member disposed between the outer tube and the resisting member; and

a torque adjusting device disposed at one end of the outer tube away from the driving member for adjusting a torque value.

Preferably, an inner edge of the sleeve member is provided with a contact portion, which is formed of a non-consecutive surface, such that the contact portion does not consecutively contact the resisting member.

Preferably, the resisting member is provided with a pushing portion and an aligning portion protruding from the pushing portion. The outer diameter of the aligning portion axially tapers away from the outer tube. The sleeve member is mounted around the pushing portion.

With such configuration, by use of the sleeve member disposed between the outer tube and the resisting member, with the non-consecutive contact relationship between the contacting portion of the sleeve member and the resisting member, the contacting square measure between the resisting member and the sleeve member is reduced, so as to lower the friction therebetween. Therefore, during the operation of the torque wrench, the sleeve member is provided with additional lubrication effect, whereby the smoothness of the sliding motion of the resisting member is improved, enhancing the torque transmission of the torque wrench. Further, when the lubrication oil is added to the resisting member, the helix shaped structure of the contact portion provides a storage space of the lubrication oil. Therefore, the necessity of regularly disassembling the torque wrench for adding the lubrication oil therein is saved, and the operation of the torque wrench is facilitated with only a small amount of lubrication oil.

In addition, during the manufacturing process of the outer tube of the present invention, the thermal processing step is allowed to be saved. The thermally-processed sleeve member fulfills the hardness and rigidity requirement of the outer tube, such that the thermal deformation issue of the outer tube during the manufacturing procedure is improved.

Also, the outer diameter of the aligning portion of the resisting member axially tapers away from the outer tube, so as to align the central point of the resilient member, and prevent the resilient member from deviating during the operation of the torque wrench, thus improving the torque transmission of the torque wrench.

### BRIEF DESCRIPTION OF THE DRAWINGS

FIG. 1 is a perspective view of the torque wrench structure in accordance with an embodiment of the present invention.

FIG. 2 is a cross-sectional view taken along line 2-2 in an embodiment illustrated by FIG. 1, illustrating that the sectional face of the aligning portion is formed in a trapezoid shape, and the fixing member is a C clamp.

FIG. 3 is a partially enlarged view of FIG. 2.

FIG. 4 is a cross-sectional view taken along line 2-2 in another embodiment illustrated by FIG. 1, illustrating that the sectional face of the aligning portion is formed in a trapezoid shape, and the fixing member is a position limiting lid.

FIG. 5 is a partially enlarged view of FIG. 4.

FIG. 6 is a cross-sectional view taken along line 2-2 in another embodiment illustrated by FIG. 1, illustrating that the sectional face of the aligning portion is formed in an arc shape.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

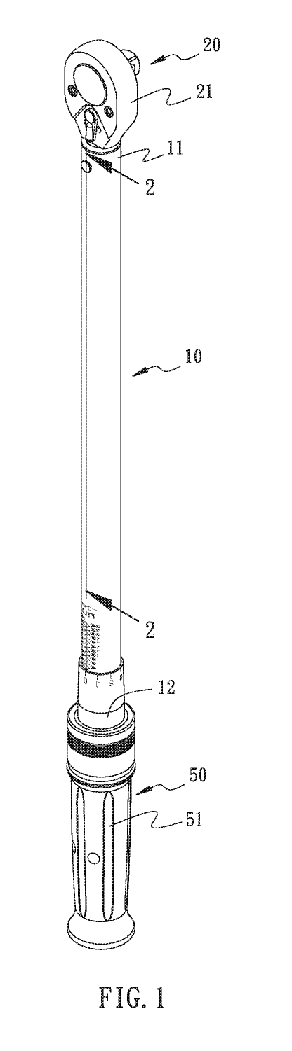

Referring to FIG. 1 to FIG. 6, a torque wrench structure in accordance with an embodiment of the present invention comprises an outer tube 10, a driving member 20, a resisting member 30, a sleeve member 40, and a torque adjusting device 50.

The outer tube 10 is provided with a front end 11 and a rear end 12, and a housing space 13 is axially disposed in the outer tube 10.

The driving member 20 has one end thereof provided with a driver 21 and the other end thereof provided with a connecting end 22. The driving member 20 is disposed at the front end 11 of the outer tube 10. The connecting end 22 is inserted into the housing space 13. The driver 21 is allowed to be an open-end wrench or a ratchet wrench. The driver 21 is applied for driving the screwing component (threat bolt or nut) or a sleeve to rotate. In an embodiment of the present invention, the driver 21 refers to a ratchet wrench.

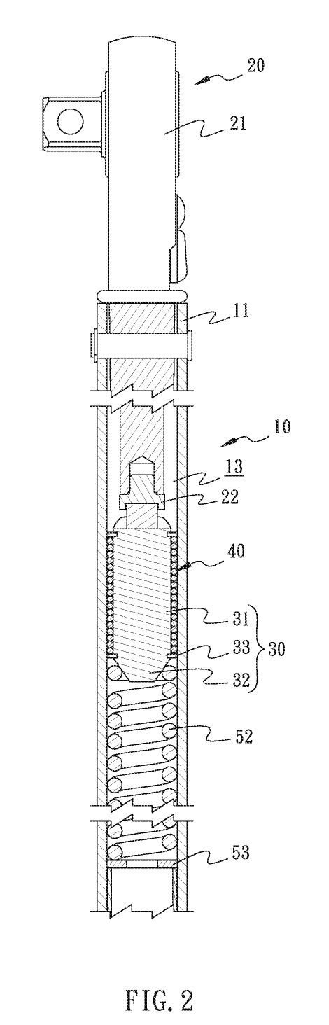

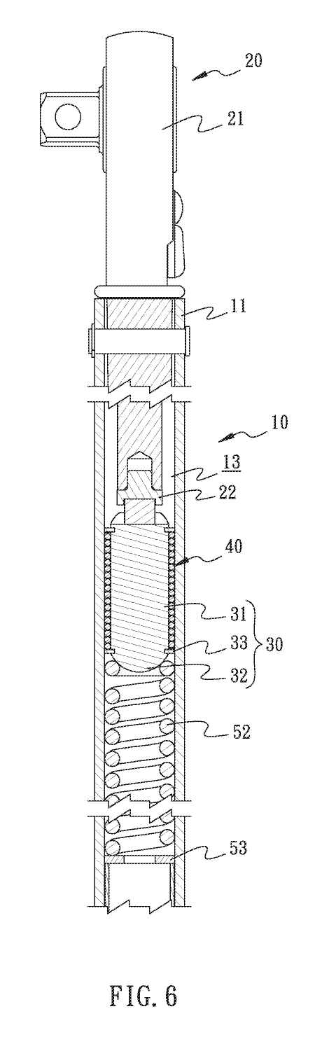

The resisting member 30 is disposed in the housing space 13 and axially slidable against the outer tube 10, and connected with the connecting end 22. The resisting member 30 is provided with a pushing portion 31 and an aligning portion 32 protruding at one end of the pushing portion 31, with the other end of the pushing portion 31 axially connected with the connecting end 22. The aligning portion 32 axially protrudes at the pushing portion 31 along the axial direction of the outer tube 10. The outer diameter of the aligning portion 32 axially tapers toward the rear end 12 away from the front end 11 of the outer tube 10. The sectional face of the aligning portion 32 is formed of a trapezoid or an arc shape. As shown in FIG. 2 to FIG. 5, the sectional face of the aligning portion 32 is formed in a trapezoid shape. As shown in FIG. 6, the sectional face of the aligning portion 32 is formed in an arc shape.

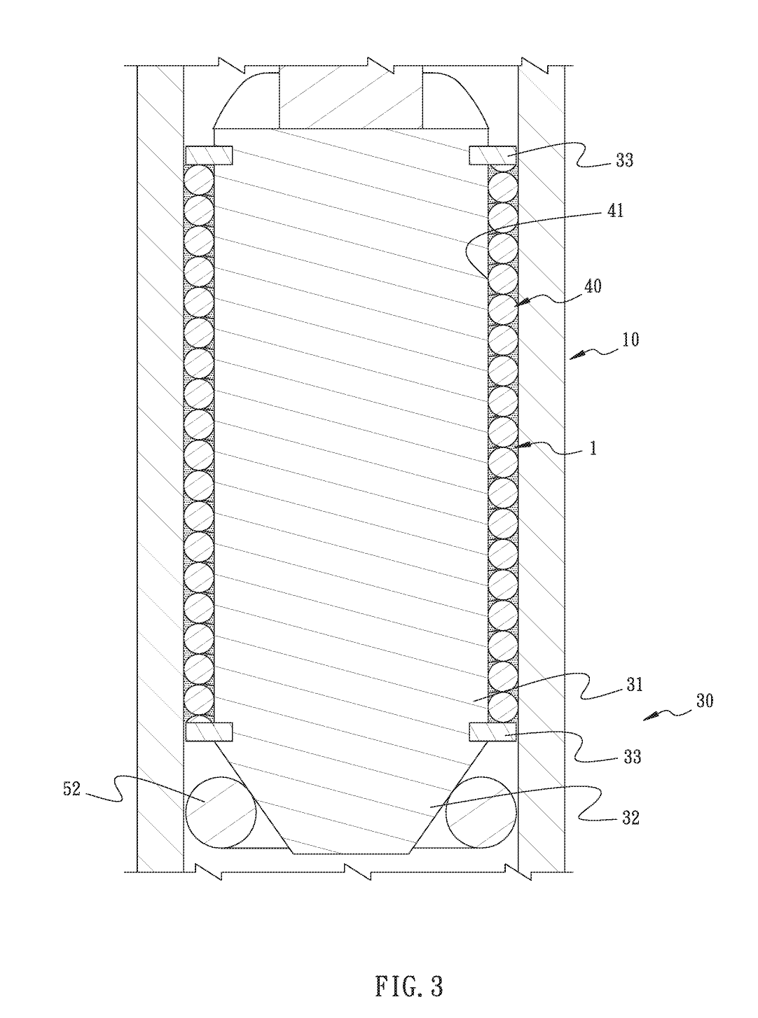

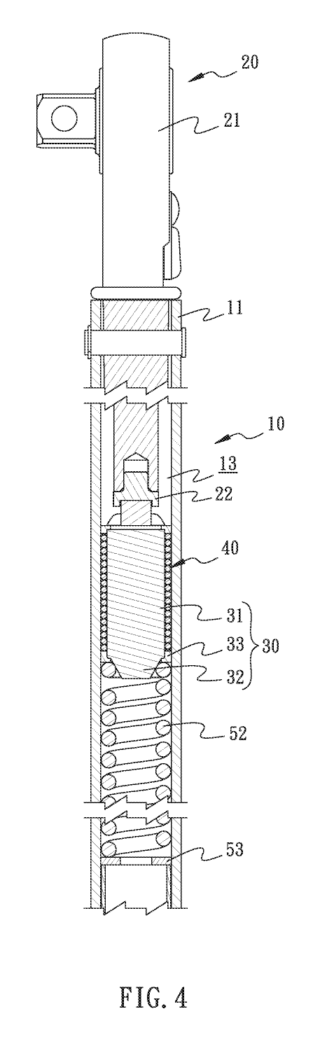

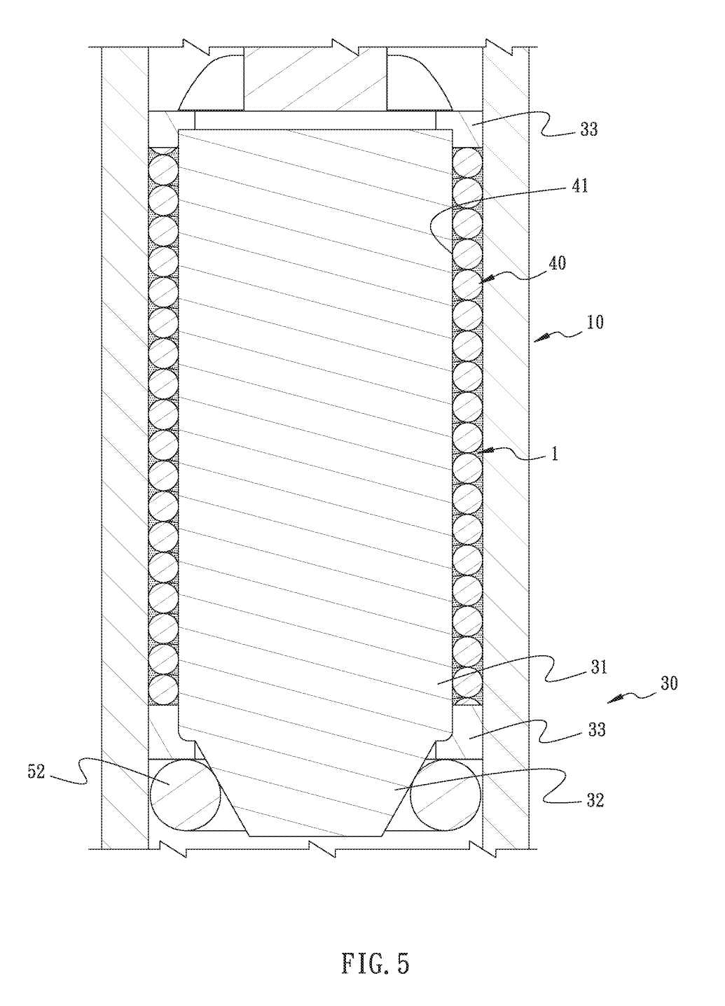

Also, two ends of the pushing portion 31 are provided with a fixing member 33, respectively, wherein the two fixing members 33 are integrally formed with the pushing portion 31. The fixing members 33 protrude at the outer side of the two ends of the pushing portion 31. Alternatively, the two fixing members 33 are disposed at two ends of the pushing portion 31. In an embodiment of the present invention, the two fixing members 33 are disposed and fixed at two ends of the pushing portion 31. As shown by FIG. 2, FIG. 3, and FIG. 6, the two fixing members 33 are both a C clamp. Alternatively, as shown by FIG. 4 and FIG. 5, the two fixing members 33 are both a position limiting lid.

The sleeve member 40 is disposed between the outer tube 10 and the resisting member 30, and is positioned between the two ends of the pushing portion 31 by the two fixing members 33. Further, the inner edge of the sleeve member 40 is provided with a contact portion 41, which is formed in a non-consecutive surface, such that the contact portion 41 dose not consecutively contact the outer side of the resisting member 30. The sleeve member 40 is mounted around the pushing portion 31, and the contact portion 41 contacts the outer wall of the pushing portion 31 in a manner of point contact. In an embodiment of the present invention, the sleeve member 40 is a spring, and the contact portion 41 is formed in a helix shape structure. When a lubrication oil 1 is added to the sleeve member 40, by use of the helix shape structure of the contact portion 41, the lubrication oil 1 is allowed to cover the helix shape structure thereof, so as to increase the storage amount of the lubrication oil 1, thus reducing the necessity of refilling times of the lubrication oil 1. In addition, when the resisting member 30 slides against the sleeve member 40, the sleeve member 40 is positioned between the two ends of the pushing portion 31 by the two fixing members 33, whereby the sleeve member 40 is prevented from being detaching from the pushing portion 31. Also, the contact portion 41 contacts the pushing portion 31 in a manner of point contact, such that the square measure of the sleeve member 40 contacting the resisting member 30 is reduced, thereby facilitating the sliding effect of the resisting member 30 in the housing space 13.

The torque adjusting device 50 is disposed at one end of the outer tube 10 away from the driving member 20. In an embodiment of the present invention, the torque adjusting device 50 is disposed at the rear end 12 of the outer tube 10. The torque adjusting device 50 includes a handle jacket 51, a resilient member 52, and a sliding member 53. The handle jacket 51 is combined with the rear end 12 of the outer tube 10 for being grip or rotate by the user in order to adjust the torque value. The resilient member 52 and the sliding member 53 are disposed in the housing space 13 and the handle jacket 51. The resilient member 52 has two ends thereof disposed between the resisting member 30 and the sliding member 53, wherein one end of the resilient member 52 is connected with the aligning portion 32. Further, the sliding member 53 is slidably disposed in the housing space 13. In an embodiment of the present invention, the resilient member 52 is a compression spring. When the user rotates a thread bolt provided at the handle jacket 51, the thread bolt causes the sliding member 53 to impose a prestress toward the resilient member 52, such that the compression strength of the resilient member 52 is controlled to adjust the torque value.

Furthermore, referring to FIG. 1 to FIG. 3, one end of the resilient member 52 partially contacts the aligning portion 32. When the user rotates the handle jacket 51 to adjust the demanded torque value, the sliding member 53 is driven by the thread bolt of the handle jacket 51 to move from the rear end 12 of the outer tube 10 to the front end 11 of the outer tube 10, whereby the sliding member 53 moves to impose the prestress to compress the resilient member 52. With the outer diameter of the aligning portion 32 tapers axially tapers away from the outer tube 10, and the aligning portion 32 only partially contacting the resilient member 52, the aligning portion 32 positions the center of the resilient member 52 at the axle center of the outer tube 10, such that the center of the resilient member 52 is prevented from deviating when the resilient member 52 is compressed. Therefore, the aligning portion 32 automatically aligns the center of the resilient member 52 with the axle center of the outer tube 10.

With the sleeve member 40 disposed between the outer tube 10 and the resisting member 30, the sleeve member 40 contacts the resisting member 30 in a manner of point contact, so as to reduce the contact square measure between the sleeve member 40 and the resisting member 30, thus lowering the friction between the sleeve member 40 and the resisting member 30. When the torque wrench structure is operated, the sleeve member 40 increases the lubrication to facilitate the sliding motion of the resisting member 30, thereby improving the torque transmission of the torque wrench structure of the present invention.

In addition, when the lubrication oil 1 is added to the sleeve member 40, the helix shape structure of the contact portion 41 provides the storage space of the lubrication oil 1, so as to reduce the necessity of refilling the lubrication oil 1. Also, the operation is facilitated with only a small amount of the lubrication oil 1.

Furthermore, in an embodiment of the present invention, the sleeve member 40 undergoes a thermal processing step. Therefore, during the manufacturing process, thermal process of the outer tube 10 of the present invention is allowed to be saved. The thermally processed sleeve member 40 is able to fulfill the hardness and rigidity requirement of the outer tube, so as to prevent the outer tube 10 from thermal deformation during the manufacturing or processing procedure.

Also, the outer diameter of the aligning portion 32 axially tapers away from the outer tube 10, such that the aligning portion 32 only partially contacts the resilient member 52. When the resilient member 52 is compressed, the aligning portion 32 is allowed to position the center of the resilient member 52 at the axle center of the outer tube 10, so as to automatically align the center of the resilient member 52 for improving the torque transmission of the torque wrench structure of the present invention.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A torque wrench structure, comprising:
an outer tube provided with an axially disposed housing space;
a driving member having one end thereof provided with a driver and the other end thereof provided with a connecting end, the driving pivotally disposed at one end of the outer tube, the connecting end inserted into the housing space;
a resisting member slidably disposed in the housing space and connected with the connecting end;
a sleeve member disposed between the outer tube and the resisting member; and
a torque adjusting device disposed at one end of the outer tube away from the driving member for being operated to adjust a torque value.

2. The torque wrench structure of claim 1, wherein an inner edge of the sleeve member includes a contact portion, the contact portion formed of a non-consecutive surface, so as to non-consecutively contact the resisting member.

3. The torque wrench structure of claim 2, wherein the contact portion contacts the resisting member in a manner of point contact.

4. The torque wrench structure of claim 1, wherein the sleeve member is a spring.

5. The torque wrench structure of claim 4, wherein the resisting member includes a pushing portion and an aligning portion protruding at the pushing portion, an outer diameter of the aligning portion axially tapering away from the outer tube, the sleeve member mounted around the pushing portion.

6. The torque wrench structure of claim 5, further comprising two fixing members disposed at two ends of the pushing portion, such that the sleeve member is positioned between the two ends of the pushing portion by the two fixing members.

7. The torque wrench structure of claim 5, wherein the torque adjusting device includes a resilient member and a sliding member, the resilient member resiliently disposed between the resisting member and the sliding member, the sliding member disposed in the housing space, the resilient member having one end thereof connected with the aligning portion.

8. The torque wrench structure of claim 7, wherein a sectional face of the aligning portion is formed in a trapezoid shape.

9. The torque wrench structure of claim 7, wherein a sectional face of the aligning portion is formed in an arc shape.
